(19) United States
(12) Patent Application Publication
(10) Pub. No.: US 2009/0201597 A1
(43) Pub. Date: Aug. 13, 2009

(54) Busterbite

(76) Inventors: Karl Johan Lindblad, Stockholm (SE); Karl Pontus Lindblad, Stockholm (SE); Anders Erik Johansson, Akersberga (SE)

Correspondence Address: Johan Lindblad, Beckomberhavahen 27, S-168 54 Bromma, SE

(21) Appl. No.: 11/547,880

(22) PCT Filed: Mar. 17, 2005
(86) PCT No.: PCT/SE05/00357

§ 371 Date: Mar. 16, 2009

(30) Foreign Application Priority Data
Mar. 19, 2004 (SE) 0400698-7

(51) Int. Cl. G02B 7/00

(52) U.S. Cl. 359/892

(57) ABSTRACT

The invention concerns an attachment device for the mounting and fixation of lighting filters. The attachment device consists of at least three tags (2), each one having an adhesive surface (7) to apply onto the edge (5) of the filter (6) and an elastic thread (3) for attachment to both a hole (4) in the respective tag (2) and the frame (8) surrounding the filter (6) in order to mount the filter (6) evenly within the frame (8).

The invention in question concerns an attachment device for mounting and fixation of lighting filters.

During the lighting process of for example film, TV and theatre productions, different lighting filters are used. These lighting filters are used to change the colour, character and direction of the light, and are normally delivered in rolls. When used, a piece of the filter is cut off and then mounted in front of the light source itself or on a frame, usually made of aluminium or wood. It is then placed in front of the light source. Sometimes a combination of different filters in the same frame is needed. The filters are generally fastened with tape, stapled or clipped to the frame. These methods are not optimal. Tape is difficult to use outdoors when the weather is cold and the frames get very sticky from repetitive use of the tape. The filters that have been mounted in frames are almost always torn when removed from the frame and can therefore not be used again.

The purpose of the invention is to solve these problems and create a new type of attachment device as mentioned above. The distinguishing characteristics of the invention are described in the following patent claims.

Thanks to the invention one has now succeeded in creating an attachment device for lighting filters which in an excellent way serves its purpose and at the same time is simple and inexpensive to manufacture. The attachment device as defined by the invention consists of two parts: a tag made of plastic with a hole in it and an elastic thread or cord. In situations involving a rectangular lighting filter, four plastic tags are used. They are partially covered with an adhesive surface on one side and are hereby easily fastened, one on each corner of the filter. Around the corners of the frame that surrounds the filter, the elastic threads can be formed into loops and their hooks can be inserted into the hole in the plastic tag. Hereby the filter is mounted in the frame in a quick and convenient way. It is also easy to add more filters to the same frame if needed. When the filter has been used it is easy to take it out of the frame, save it and reuse it at a later occasion. This enables a very cost effective and environmentally friendly use of the filter. The plastic tags are for one time use only, as they stick to the filter and cannot be removed. The elastic threads however, can be use several times.

The invention is described in greater detail below as an example of filter mounting referring to enclosed drawings, where

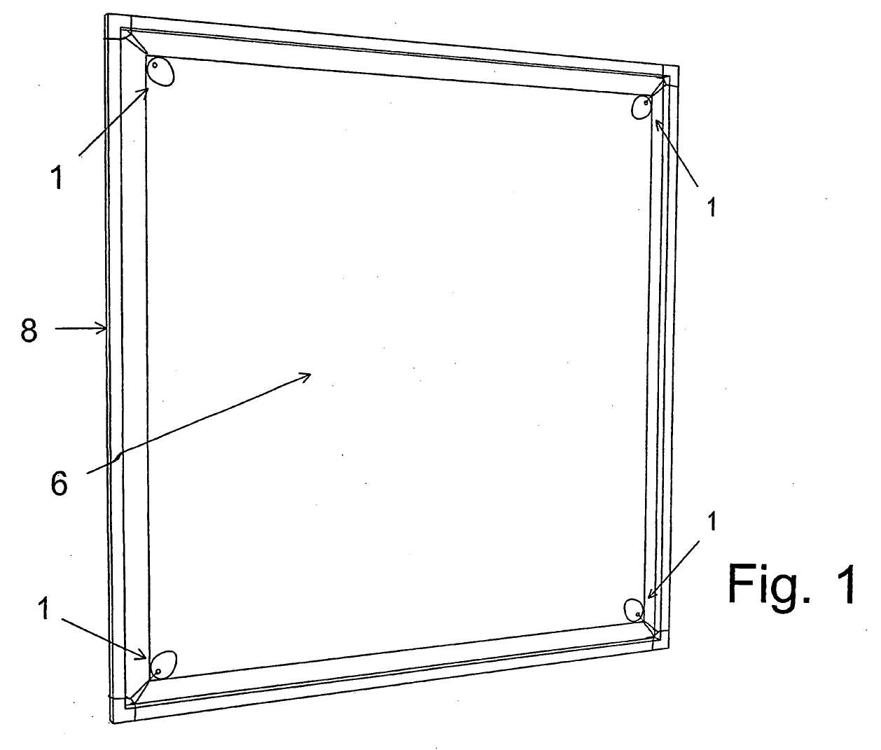

FIG. 1 shows an outlined perspective view of the attachment device as defined by the invention when it is being used for the mounting of a lighting filter in a frame made for example of aluminium,

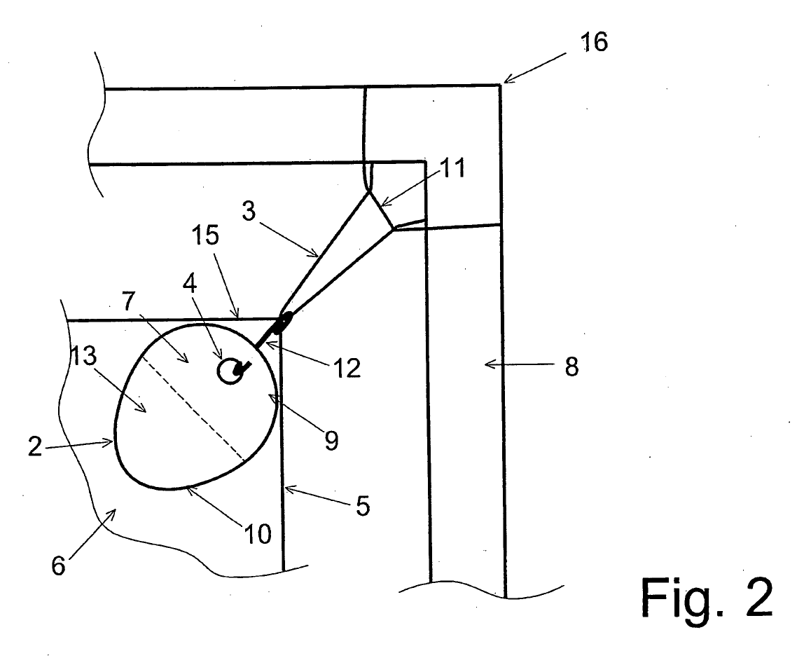

FIG. 2 shows an outlined partial side-view of a corner of the frame in FIG. 1 with a mounted lighting filter,

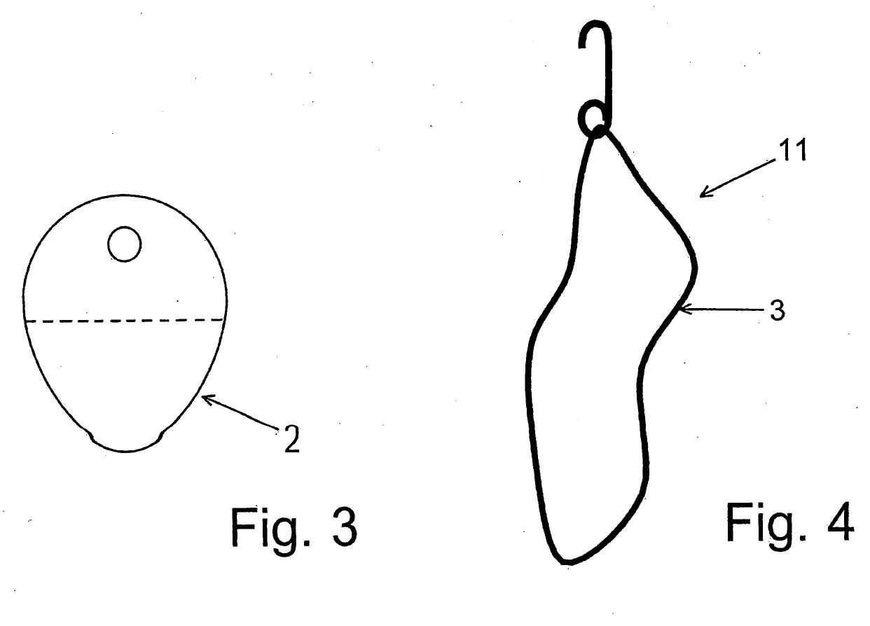

FIG. 3 shows an enlarged view of a plastic tag, which is a part of the attachment device as defined by the invention, and

FIG. 4 shows an enlarged view of the elastic thread, which is a part of the attachment device as defined by the invention.

As one can see, the drawings display a filter mounting example of an attachment device as defined by the invention for the mounting and fixation of a lighting filter 6 in a frame 8. In this displayed example, four attachment devices 1 are used for the mounting of the lighting filter 6 in the frame 8. Each of these attachment devices 1 consists of a tag 2 where each of the tags 2 have an adhesive surface 7 to stick on the edge 5 of the filter 6, and an elastic thread or cord 3 that works both with a hole 4 in each tag 2 and the frame 8 that surrounds the filter 6. With this arrangement, the filter 6 can be evenly mounted in the frame 8.

The tag 2 is preferably made of a plastic material that has a stiffness exceeding that of the filter. In the displayed example, one side 9 of the tag 2 constitutes the mentioned adhesive surface 7 for the edge 5 of the filter 6 and the hole 4 for the hook 12 and the other side 10 of the tag 2 has a handling surface 13 so that the adhesive will not lose its adhesive capacity during handling of the tag 2. The adhesive surface 7 of the tag 2 can have a protective coat made of paper or plastic which is easily removed when the tag 2 is used. The elastic thread 3 has in the displayed example the form of a loop 11 with a hook 12 that is intended to be inserted through the hole 4 in the tag 2.

The filter 6 normally has the same shape as the frame 8 in which it is being mounted, under the condition that a certain space exists between the edge 5 of the filter 6 and the frame 8 that surrounds it. Using a rectangular frame and a rectangular filter makes the filter easy to mount and fixate with the attachment device 1 in the respective corners 15 and 16 of the filter 6 and the frame 8. The thread 3 is used to mount the filter 6 by putting the loops 11 around the corners 16 on the frame 8 and thereafter, using the hook 12, mounting the filter 6 via the holes 4 on the tags 2. Through this arrangement the filter is easy to remove from the frame and can be reused when a filter of the same kind is needed again.

1. Attachment device for mounting and fixation of lighting filters, characterized by at least three tags (2), each of them having an adhesive surface (7) to apply on the edge (5) of the filter (6) and an elastic thread or cord (3) for attachment to both the hole (4) in each tag (2) and the frame (8) surrounding the filter (6) in order to mount the filter (6) evenly within the frame (8).

2. Attachment device as defined by patent claim 1, characterized by the tag (2) which is manufactured in a plastic material that has a stiffness exceeding that of the filter, where one side (9) of the tag (2) has the aforementioned adhesive surface (7) for the edge (5) of the filter (6), and also by the tag's (2) aforementioned hole (4) for the loop (11).

3. Attachment device according to patent claim 1, characterized by the elastic thread (3) which has the form of a loop (11) with a hook (12).

4. Attachment device according to patent claim 1, characterized by the filter (6) being rectangular and having a surrounding frame (8) in which the filter (6) can be mounted with its attachment devices (1) in the respective corners (15,16) of the filter (6) and the frame (8).

5. Attachment device according to any of the above mentioned patent claims, characterized by the filter (6) that can be mounted with the loops (11) which can be placed around the corners (16) of the frame (8) and then fastened to the tags (2).
